(19) United States
(12) Patent Application Publication
(10) Pub. No.: US 2009/0307354 A1
(43) Pub. Date: Dec. 10, 2009

(54) Wireless Communication System and Related Method Capable of Sharing System Resource

(76) Inventor: Jian-Jun Qian, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/436,776

(22) Filed: May 6, 2009

(30) Foreign Application Priority Data
Jun. 6, 2008 (CN) 200810108492.0

(51) Int. Cl. G06F 15/173; H04B 7/00

(52) U.S. Cl. 709/226; 455/41.2

(57) ABSTRACT

A wireless communication system capable of sharing system resource includes a wireless communication device for performing a first wireless communication function, and a plurality of electronic devices each including an interface for coupling the wireless communication device by means of plug and play, an operating unit for performing a function of each electronic device, a wireless communication unit for performing a second wireless communication function, a detection unit coupled to the interface for detecting whether the wireless communication device is coupled to the interface, and a control unit coupled to the detection unit and the operating unit for controlling the operating unit to perform the first communication function via the interface according to a detection result provided by the detection unit.

### BACKGROUND OF THE INVENTION

1. Field of the Invention

The present invention is related to a wireless communication system capable of sharing system resource and related method, and more particularly, to a wireless communication system which can save system resource and improve users' convenience and the related method.

2. Description of the Prior Art

Coming with the development of science and technology and the advancement of modern economy, portable electronic devices (to name a few, notebook computer, mobile phone, PDA, etc.) are getting more popular and often to be used in everyday lives. Generally speaking, every portable electronic device can be considered as a complete operating device and is capable of performing one or several specific functions. However, different portable devices may have system functions in common but not to be shared with others. For example, it is now easy to find a mobile phone and a notebook computer which both have the functions to do wireless connections to Internet, but according to the prior art, it is uneasy for a user to connect to Internet on the mobile phone via the notebook computer; meanwhile, it is also uneasy for a user to dial a phone call on the notebook computer via the mobile phone.

### SUMMARY OF THE INVENTION

It is therefore a primary objective of the claimed invention to provide a wireless communication system capable of sharing system resource and the related method.

The present invention discloses a wireless communication system capable of sharing system resource, which comprises a wireless communication device for performing a first wireless communication function, and a plurality of electronic devices each comprising an interface for coupling the wireless communication device by means of plug and play, an operating unit for performing a function of each electronic device, a wireless communication unit for performing a second wireless communication function, a detection unit coupled to the interface for detecting whether the wireless communication device is coupled to the interface, and a control unit coupled to the detection unit and the operating unit for controlling the operating unit to perform the first communication function via the interface according to a detection result provided by the detection unit, wherein while the wireless communication device couples to the interface of a first electronic device of the plurality of electronic devices, a second electronic device of the plurality of the electronic devices performs connection with the first electronic device via the second wireless communication function of the wireless communication control unit, so as to perform the first wireless communication function via the first electronic device.

The present invention further discloses a system resource sharing method for a wireless communication system. The wireless communication system comprises a wireless communication device for performing a first wireless communication function and a plurality of electronic devices. The method comprises being coupled to a first electronic device of the plurality of electronic devices by the wireless communication device, performing a second wireless communication function for connecting with the first electronic device by a second electronic device of the plurality of electronic devices, and performing the first wireless communication function via the first electronic device by the second electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is the schematic diagram of an embodiment of a wireless communication system.

FIG. 2 is the functional block diagram of an electronic device given in FIG. 1.

FIG. 3 is the schematic diagram of a flowchart of an embodiment of the present invention applies to the wireless communication system capable of sharing system resource shown in FIG. 1.

FIG. 4 is the schematic diagram of a wireless communication system of the embodiment of the present invention.

### DETAILED DESCRIPTION

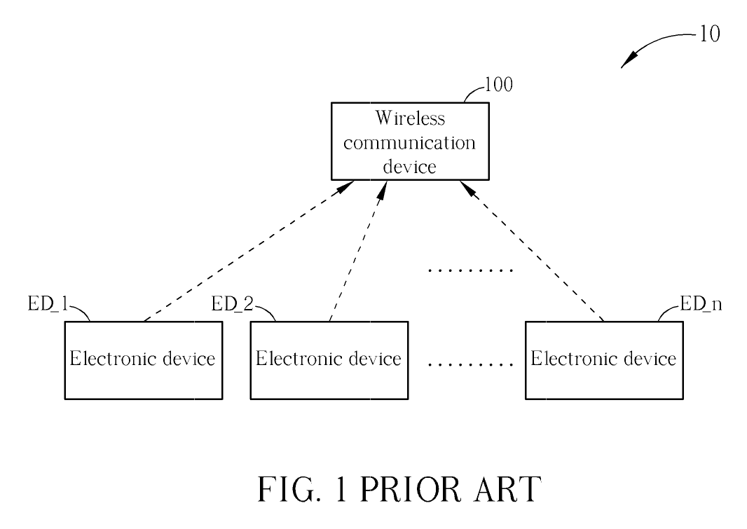

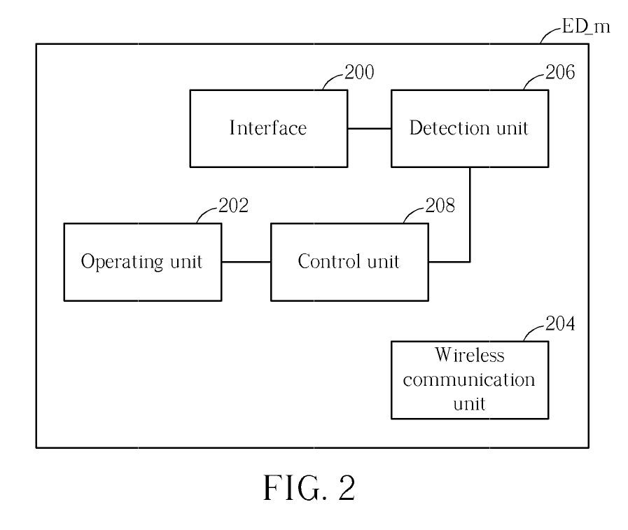

Please refer to FIG. 1. FIG. 1 is a schematic diagram of a wireless communication system 10 according to an embodiment of the present invention. The wireless communication system 10 can share system resources, and comprises a wireless communication device 100 and a plurality of electronic devices ED_1˜ED_n. The wireless communication device 100 can perform a first wireless communication function, like mobile communication function or wireless network connection function, etc. The electronic devices ED_1˜ED_n function independently, and can be popular electronic products, like notebook computer, mobile phone, PDA, or other electronic products with operating capability. Please continue to refer to FIG. 2. FIG. 2 is a functional block diagram of an electronic device ED_m given in FIG. 1. The electronic device ED_m comprises an interface 200, an operating unit 202, a wireless communication unit 204, a detection unit 206 and a control unit 208. The interface 200 is used for coupling the wireless communication device 100 by means of plug and play. The operating unit 202 is used to perform the functions of the electronic device ED_m, and can comprise other components, like display module, input module, storage module, CPU, etc., and is not limited to. The wireless communication operating unit 204 is used to perform a second wireless communication function, and preferably to be a bluetooth communication function. The detection unit 206 is coupled to the interface 200, and is used to test whether the wireless communication device 100 is properly coupled to the interface 200. The control unit 208 is coupled to the detection unit 206 and the operating unit 202, and is used to control the operating unit 208 via the interface 200 to perform the first wireless communication function based on the test result of the detection unit 206.

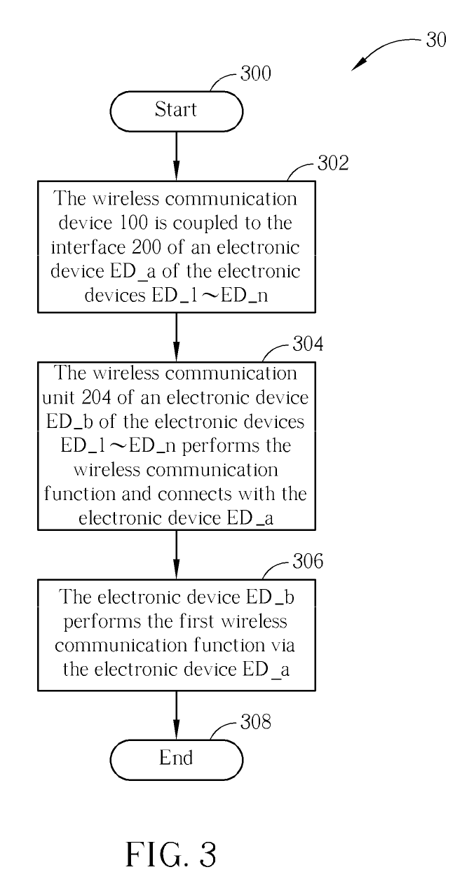

With regard to the operation method of the wireless communication system 10, please continue and refer to FIG. 3. FIG. 3 is a schematic diagram of a process 30 according to an embodiment of the present invention. The process 30 is applied to the wireless communication system 10 capable of sharing system resource, and comprises the following steps:

STEP 300: Start.

STEP 302: The wireless communication device 100 is coupled to the interface 200 of an electronic device ED_a of the electronic devices ED_1 ˜ED_n.

STEP 304: The wireless communication unit 204 of an electronic device ED_b of the electronic devices ED_1˜ED_n performs the wireless communication function and connects with the electronic device ED_a.

STEP 306: The electronic device ED_b performs the first wireless communication function via the electronic device ED_a.

STEP 308: End.

According to the process 30, when the wireless communication device 100 is coupled to the electronic device ED_a, the electronic device ED_a can perform the first wireless communication function of the wireless communication device 100; meanwhile, the electronic device ED_b can connect to the electronic device ED_a via the wireless communication unit 204, and perform the first communication function via the electronic device ED_a. In other words, in the wireless communication system 10, the electronic device ED1˜ED_n are capable of sharing the wireless communication function of the wireless communication device 100. Therefore, the present invention can save system resource and increase the convenience.

In the present invention, the wireless communication device 100 connects to an electronic device by means of plug and play, which allows the electronic device to perform the first communication function of the wireless communication device 100, and the other electronic devices can connect to the electronic device via the second wireless communication function to perform the first wireless communication function. Note that, FIG. 1 is the schematic diagram of the preferred embodiment of the present invention, and those skilled in the art can make modifications and alterations accordingly. For example, the number of the electronic devices ED_1˜ED_n is not limited to any specific quantity as long as it is greater than 1, and the electronic devices ED_1˜ED_n can be realized by often seen electronic products, like notebook computer, mobile phone, PDA, etc.

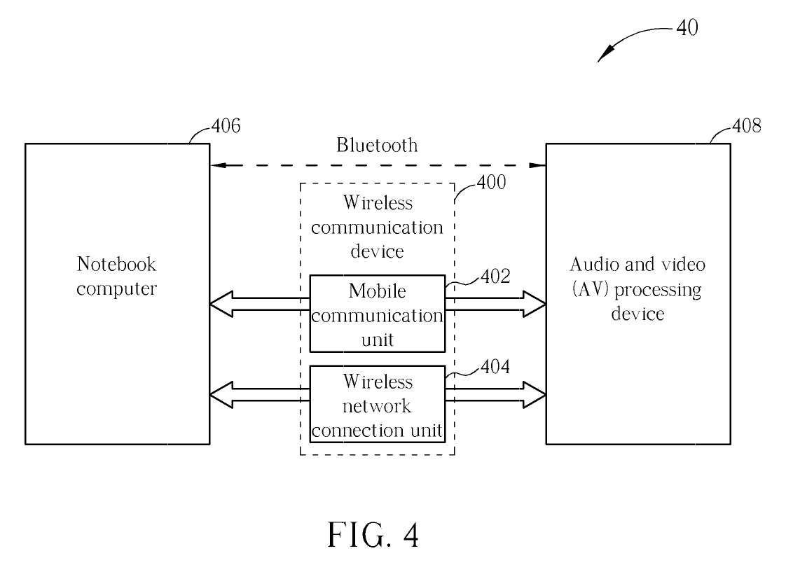

Please refer to FIG. 4. FIG. 4 is a schematic diagram of a wireless communication system 40 according to an embodiment of the present invention. The wireless communication system 40 is a special embodiment of the wireless communication system 10, and comprises a wireless communication device 400, a notebook computer 406 and an audio and video (AV) processing device 408. The wireless communication device 400 comprises a mobile communication unit 402 and a wireless network connection unit 404 to perform the mobile communication function and the wireless network connection function, respectively. The notebook computer 406 and the AV processing device 408 can perform the plug and play to the wireless communication device 400 to perform the mobile communication function or the wireless network connection function. Simultaneously, the notebook computer 406 and the AV processing device 408 can establish the wireless connection via the bluetooth communication function.

To demonstrate the operation of the wireless communication system 40 more clearly, first, if the wireless communication device 400 couples to the notebook computer 406, then the notebook computer 406 can connect to the wireless communication connection unit 404 via the mobile communication unit 402 and the wireless communication connection unit 404. Meanwhile, the AV processing unit 408 and the notebook computer 406 can establish the wireless connection to perform the mobile communication function or the wireless network connection function via the notebook computer 406. For example, if the notebook computer 406 performs the mobile communication function via the mobile communication unit 402, the function of the notebook computer 406 can be analogous to a mobile phone, and the AV processing device 408 can behave like a handset. Under this condition, if the AV processing device 408 has better portability, the user can put the notebook computer 406 in the backpack or the desk drawer while the user can make a phone call via the AV processing device 408. Similarly, if the notebook computer 406 performs the wireless network connection function via the wireless network connection unit 404, since the video and audio processing device 408 already makes wireless connection with the notebook computer 406, the AV processing device 408 can access wireless network via the notebook computer 406. Under this condition, if the AV processing device 408 has better portability, the user can put the notebook computer 406 in the backpack or the desk drawer while the user can browse Internet or send/receive emails via the AV processing device 408.

On the contrary, if the wireless communication device 400 is coupled to the AV processing device 408, then the AV processing device 408 can perform the mobile communication function or wireless network connection function via the mobile communication unit 402 and the wireless network connection unit 404. Meanwhile, the notebook computer 406 can make a wireless connection with the AV processing device 408, and perform mobile communication function or wireless network connection function via the AV processing device 408. For example, if the AV processing device 408 performs mobile communication function via the mobile communication unit 402, then the function of the AV processing device 408 will be analogous to a mobile phone, and the notebook computer 406 will function like a handset. Under this condition, the user can use the default functions of the notebook computer 406 as well as make a phone call at the same time. Similarly, if the AV processing device 408 performs the wireless network connection function via the wireless network connection unit 404, since the notebook computer 406 already makes wireless connection to the AV processing device 408, the notebook computer 406 can access the wireless network via the AV processing device 408. Under this condition, the user can use the default functions of the notebook computer 406, as well as browse Internet or send/receive emails.

Therefore, by way of the wireless communication system 40, the notebook computer 406 and the AV processing device 408 can establish wireless connection via the bluetooth communication function, and the notebook computer 406 and the AV processing unit 408 can thus share the resource of the wireless communication device 400.

To make a summary, according to the present invention, the wireless communication device can connect to an electronic device by means of plug and play, such that the electronic device can perform the first wireless communication function of the wireless communication device, and the other electronic devices can connect to the electronic device via the second communication function, and then perform the first wireless communication function. By using the present invention, the system resource can be saved, and the users' convenience can be improved.

Those skilled in the art will readily observe that numerous modifications and alterations of the device and method may be made while retaining the teachings of the invention.

What is claimed is:

1. A wireless communication system capable of sharing system resource comprising:
a wireless communication device for performing a first wireless communication function; and
a plurality of electronic devices each comprising:
an interface for coupling the wireless communication device by means of plug and play;
an operating unit for performing a function of each electronic device;
a wireless communication unit for performing a second wireless communication function;
a detection unit coupled to the interface for detecting whether the wireless communication device is coupled to the interface; and
a control unit coupled to the detection unit and the operating unit for controlling the operating unit to perform the first communication function via the interface according to a detection result provided by the detection unit;
wherein while the wireless communication device couples to the interface of a first electronic device of the plurality of electronic devices, a second electronic device of the plurality of the electronic devices performs connection with the first electronic device via the second wireless communication function of the wireless communication control unit, so as to perform the first wireless communication function via the first electronic device.

2. The wireless communication system of claim 1, wherein the first wireless communication function is a mobile communication function.

3. The wireless communication system of claim 1, wherein the first wireless communication function is a wireless network connection function.

4. The wireless communication system of claim 1, wherein the second wireless communication function is a bluetooth communication function.

5. The wireless communication system of claim 1, wherein the plurality of the electronic devices comprise a notebook computer.

6. The wireless communication system of claim 1, wherein the plurality of the electronic devices comprise an audio and video processing device.

7. A system resource sharing method for a wireless communication system comprising a wireless communication device for performing a first wireless communication function and a plurality of electronic devices, the method comprising:
being coupled to a first electronic device of the plurality of electronic devices by the wireless communication device;
performing a second wireless communication function for connecting with the first electronic device by a second electronic device of the plurality of electronic devices; and
performing the first wireless communication function via the first electronic device by the second electronic device.

8. The method of claim 7, wherein the first wireless communication function is a mobile communication function.

9. The method of claim 7, wherein the first wireless communication function is a wireless network connection function.

10. The method of claim 7, wherein the second wireless communication function is a bluetooth communication function.

11. The method of claim 7, wherein the plurality of the electronic devices comprise a notebook computer.

12. The method of claim 7, wherein the plurality of the electronic device comprise a mobile phone.
